(19) United States
(12) Patent Application Publication
(10) Pub. No.: US 2009/0317570 A1
(43) Pub. Date: Dec. 24, 2009

(54) Shell with printing patterns for a vehicl and method for forming the same

(76) Inventors: Da-Sen Lin, Taichung (TW); Chien-Liang Lin, Taichung (TW)

Correspondence Address: JACKSON WALKER, L.L.P., 112 E. PECAN, SUITE 2400, SAN ANTONIO, TX, 78205, US

(21) Appl. No.: 12/214,373

(22) Filed: Jun. 18, 2008

(51) Int. Cl. B60R 13/04

(52) U.S. Cl. 428/31

(57) ABSTRACT

A shell with printing patterns has a shell body, a printing layer and an electroplating layer. The shell body has an outer surface and an area. The printing layer is attached to the outer surface of the shell body to form the printing patterns and has an area smaller than that of the shell body. The electroplating layer is attached to the outer surface of the shell body at a region beside the printing layer.

### BACKGROUND OF THE INVENTION

1. Field of the Invention

The present invention relates to a shell, and more particularly to a shell with printing patterns for a vehicle and a method for forming the same.

2. Description of Related Art

Patterns, such as trademarks are always formed on a shell of a vehicle for decoration or distinction. To form patterns on a shell of a vehicle, a metal or plastic tag or an adhesive paper/film with patterns is used. However, to attach a tag or paper onto the shell always uses glue, but the tag or paper easily falls off from the shell after a period of use. Bubbles easily occur between the tag or paper and the shell to cause the appearance of the shell unaesthetic.

To overcome the shortcomings, the present invention tends to provide a shell for a vehicle to mitigate or obviate the aforementioned problems.

### SUMMARY OF THE INVENTION

The main objective of the invention is to provide a shell with printing patterns for a vehicle and a method for forming the same. The shell has a shell body, a printing layer and an electroplating layer. The shell body has an outer surface and an area. The printing layer is attached to the outer surface of the shell body and has an area smaller than that of the shell body. The electroplating layer is attached to the outer surface of the shell body at a region beside the printing layer.

The method for forming patterns on a shell comprises acts of:

a) providing a shell body with an outer surface for a vehicle;

b) printing a printing layer onto the outer surface of the shell body; and

c) electroplating to forming an electroplating layer on the outer surface of the shell body at a region beside the printing layer.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a vehicle with a shell in accordance with the present invention;

FIG. 1A is an enlarged perspective view of the shell in FIG. 1;

FIG. 2 is an enlarged cross sectional side view of a first embodiment of a shell in accordance with the present invention;

FIG. 3 is an enlarged cross sectional side view of a second embodiment of a shell in accordance with the present invention;

FIG. 4 is an enlarged cross sectional side view of a third embodiment of a shell in accordance with the present invention;

FIG. 5 is a block diagram of a method for forming a shell in accordance with the present invention;

FIG. 6 is operational cross sectional side views showing the method for forming the shell in FIG. 5;

FIG. 7 is an enlarged perspective view of another embodiment of a shell in accordance with the present invention;

FIG. 8 is operational cross sectional side views showing the method for forming the shell in FIG. 7; and

FIG. 9 is a perspective view of another vehicle with a shell in accordance with the present invention.

### DETAILED DESCRIPTION OF PREFERRED EMBODIMENT

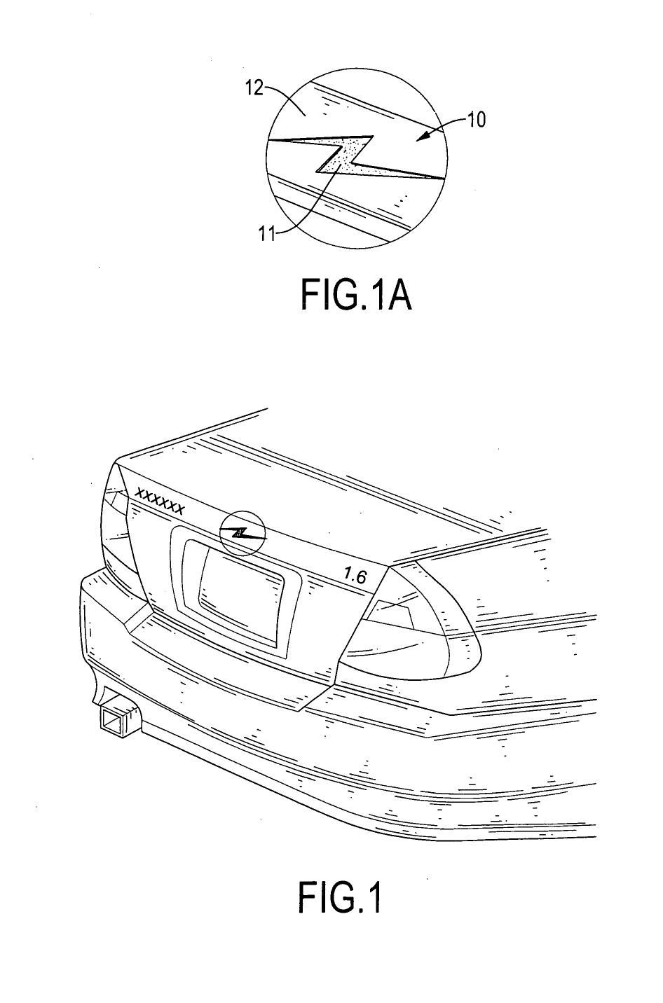

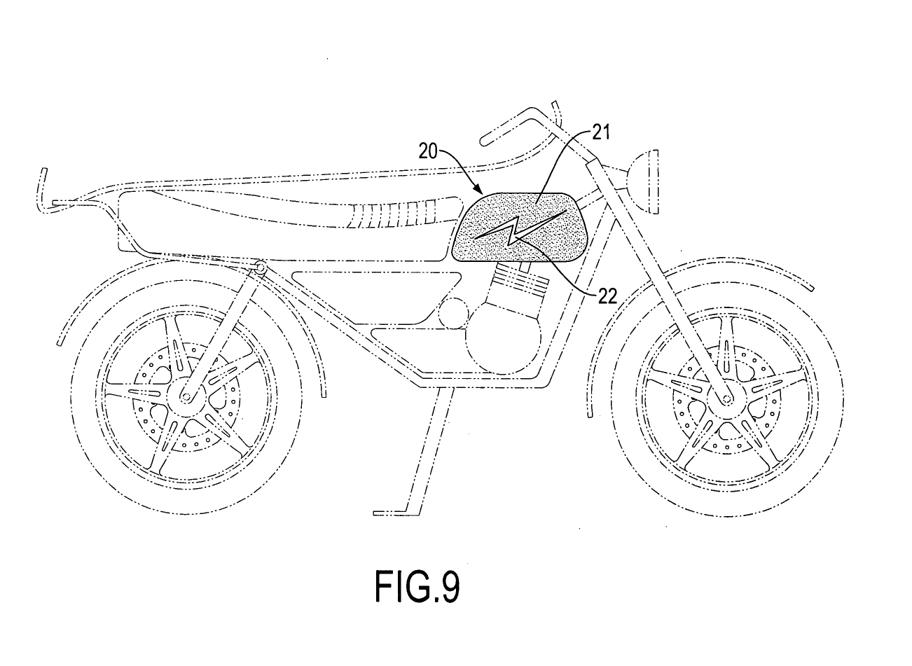

With reference to FIGS. 1, 1A and 9, a shell for a vehicle, such as a car or a motorcycle in accordance with the present invention comprises a shell body (10,20), a printing layer (11,21) and an electroplating layer (12,22).

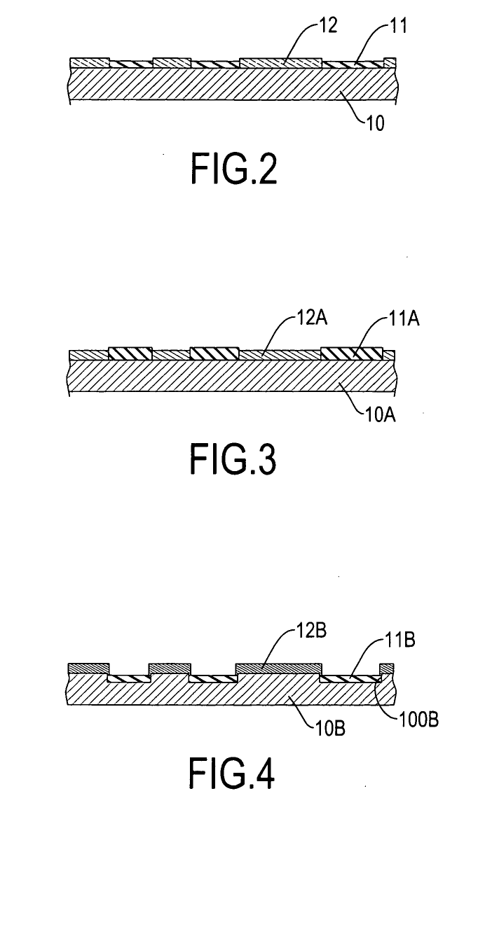

With further reference to FIGS. 2 to 4, the shell body (10,10A,10B) is made of metal or plastic material and has an outer surface and an area. The printing layer (11,11A,11B) is attached to the outer surface of the shell body (10,10A,10B) with a printing process in a single color or multiple colors and has an area smaller than that of the shell body (10,10A,10B). The electroplating layer (12,12A,12B) is attached to the outer surface of the shell body (10,10A,10B) with an electroplating process and at a region beside the printing layer (11,11A,11B). The thickness of electroplating layer (12,12A) may be equal to, larger or smaller than that of the printing layer (11,11A). In addition, the shell body (10B) may further have at least one cavity (10B) defined in the outer surface, and the printing layer (11B) is mounted in the cavity (100B) in the shell body (10B) as shown in FIG. 4.

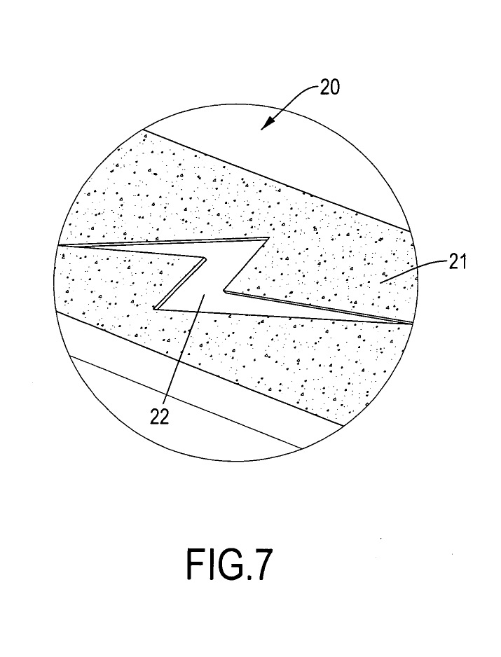

In an embodiment as show in FIG. 1, the electroplating layer (12,12A,12B) is mounted around the printing layer (11,11A,11B). In an alternative embodiment as shown in FIGS. 7 and 9, the printing layer (21) on the shell body (20) is mounted around the electroplating layer (22).

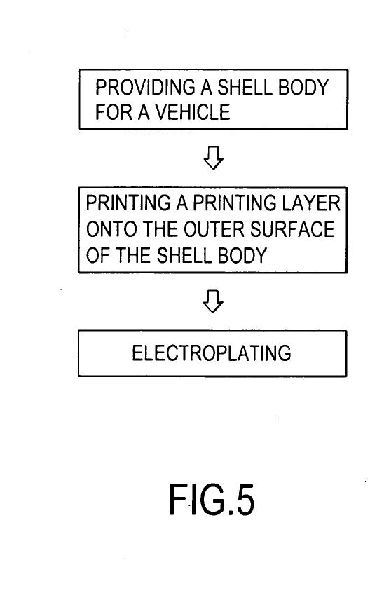

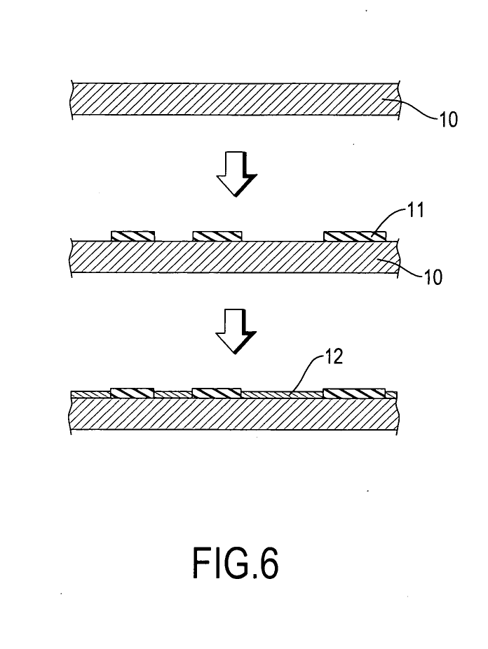

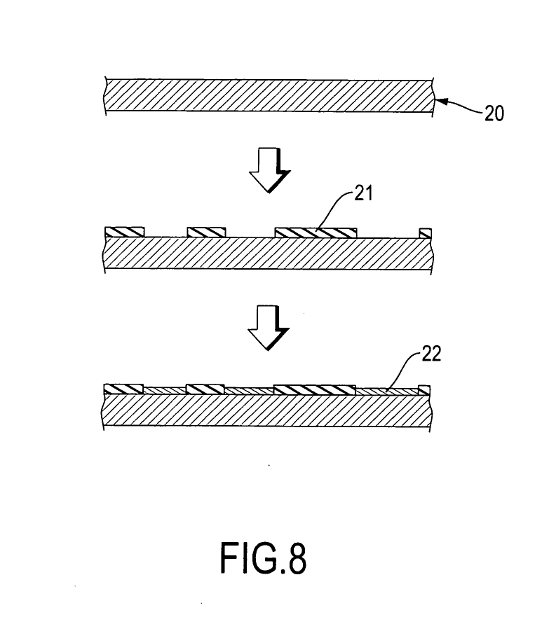

With reference to FIGS. 5, 6 and 8, a method for forming a shell in accordance with the present invention comprises acts of:

a) Providing a shell body (10,20) with an outer surface for a vehicle.

b) Printing a printing layer (11,21) onto the outer surface of the shell body (10,20). The printing layer (11,21) is printed onto the outer surface of the shell body (10,20) in a single color or multiple colors to form patterns on the shell body (10,20). Because the shell body (10,20) has a rough surface before an electroplating process is applied, the printing layer (11,21) can be easily and securely formed on the rough outer surface of the metal shell body (10,20).

c) Electroplating. Forming the electroplating layer (12,22) on the outer surface of the shell body (10,20) with an electroplating process. Because the printing layer (11,21) is isolated, the area of the printing layer (11,21) on the metal shell body (10,20) can be kept from forming the electroplating layer (12,22). Accordingly, the electroplating layer (12,22) is formed on a region beside the printing layer (11,21).

Because the patterns on the shell are constructed by the printing layer (11,21), the patterns can be smoothly and flatly formed on the shell to make the appearance of the shell aesthetic. The printing layer (11,21) is not easily even impossibly detached from the shell, the shell with printing patterns is durable. In addition, the thicknesses of the printing and electroplating layers (11,12,21,22) can be controlled to form relief or intaglio patterns on the shell, such that the appearance of the shell is versatile and aesthetic.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A shell for a vehicle comprising:
a shell body with an outer surface and an area;
a printing layer attached to the outer surface of the shell body and having an area smaller than that of the shell body; and
an electroplating layer attached to the outer surface of the shell body at a region beside the printing layer.

2. The shell as claimed in claim 1, wherein the electroplating layer has a thickness larger than that of the printing layer.

3. The shell as claimed in claim 1, wherein the electroplating layer has a thickness smaller than that of the printing layer.

4. The shell as claimed in claim 1, wherein the shell body has a cavity defined in the outer surface; and
the printing layer is mounted in the cavity in the shell body.

5. The shell as claimed in claim 1, wherein the electroplating layer is mounted around the printing layer.

6. The shell as claimed in claim 2, wherein the electroplating layer is mounted around the printing layer.

7. The shell as claimed in claim 3, wherein the electroplating layer is mounted around the printing layer.

8. The shell as claimed in claim 4, wherein the electroplating layer is mounted around the printing layer.

9. The shell as claimed in claim 1, wherein the printing layer is mounted around the electroplating layer.

10. The shell as claimed in claim 2, wherein the printing layer is mounted around the electroplating layer.

11. The shell as claimed in claim 3, wherein the printing layer is mounted around the electroplating layer.

12. The shell as claimed in claim 4, wherein the printing layer is mounted around the electroplating layer.

13. A method for forming patterns on a shell comprising acts of:
a) providing a shell body with an outer surface for a vehicle;
b) printing a printing layer onto the outer surface of the shell body; and
c) electroplating to forming an electroplating layer on the outer surface of the shell body at a region beside the printing layer.
